(19) United States
(12) Patent Application Publication
(10) Pub. No.: US 2006/0135725 A1
(43) Pub. Date: Jun. 22, 2006

(54) New balloon materials

(75) Inventors: Jan Weber, Maple Grove, MN (US); John J. Chen, Plymouth, MN (US)

Correspondence Address: VIDAS, ARRETT & STEINKRAUS, P.A., 6109 BLUE CIRCLE DRIVE, SUITE 2000, MINNETONKA, MN, 55343-9185, US

(73) Assignee: Scimed Life Systems, Inc., Maple Grove, MN (US)

(21) Appl. No.: 11/019,492

(22) Filed: Dec. 21, 2004

(51) Int. Cl. C08G 18/00

(52) U.S. Cl. 528/44

(57) ABSTRACT

A medical device, such as a catheter, catheter balloon, stent, blood filter, endoscope or portion thereof, comprises a segmented polymer, having a plurality of hard segments and a plurality of soft segments. The polymer hard segments have a substantially uniform molecular weight distribution. The molecular weight distribution ratio, Mw/Mn, may be 1.5 or less.

### BACKGROUND OF THE INVENTION

This invention is related to polymeric materials for medical devices, such as catheters, balloons, and the like.

Block copolymers have substantial uses in medical devices, for instance as materials for balloons, catheters, and layers or segments thereof, and as components of blends for such uses. Patents describing such uses include U.S. Pat. No. 6,200,290 Burgmeier; U.S. Pat. No. 4,950,239, Gahara, et al.; U.S. Pat. No. 5,433,713, Trotta; U.S. Pat. No. 5,500,180, Anderson, et al.; U.S. Pat. No. 5,556,383, Wang, et al.; U.S. Pat. No. 6,620,127, Lee, et al.; U.S. Pat. No. 6,554,795, Bagaoisan, et al.; U.S. Pat. No. 6,086,556, Hamilton, et al.; U.S. Pat. No. 5,833,657, Reinhardt, et al.; and U.S. Pat. No. 5,908,406, Ostapchenko, et al.

In the particular case of balloons, such devices desirably possess both strength that gives high burst pressure & low compliance, and flexibility that gives softness and trackability.

Heretofore evaluation has been limited largely to materials that are provided by different manufacturers and in different grades. Current commercial block copolymers used as balloon materials are specific grades of polyester block copolymers (Amitel® or Hytrel®), polyamide block copolymers (Pebax®), and polyurethanes (Pellethane®). However the range of properties desired does not always match the available commercial products, and attempts to provide a wider range of properties through blends and laminates are not very satisfactory in producing high strength, low compliance and high flexibility and softness.

### SUMMARY OF THE INVENTION

The present invention pertains to medical device comprising a segmented polymer, the polymer having a plurality of hard segments and a plurality of soft segments, wherein the polymer hard segments have a substantially uniform molecular weight distribution.

The segmented polymer may be a reaction product of a difunctional hard segment precursor moiety and a co-reactive difunctional soft segment precursor moiety, wherein, before reaction thereof with said difunctional soft segment precursor moiety to produce said reaction product, the difunctional hard segment precursor moiety was processed to provide a molecular weight distribution ratio, Mw/Mn, of 1.5 or less.

Exemplary hard segments for the polymers used in this invention include aromatic polyester such as PET and PBT, aromatic polyamides such as poly(phenylene terephthalamide), aliphatic polyamides, polyimides and polyurethane-urea. The soft segments include polyether, polyester and functionalized polyolefin.

### DETAILED DESCRIPTION OF THE INVENTION

In the polymers utilized in the present invention, the hard segments are suitably prepared separately in a manner that facilitates a narrow distribution product and/or is subsequently purified to provide a uniform molecular weight distribution.

The hard segments may be formed with amide, ester, aromatic ether, imide, ureide and/or urethane linkages. In some embodiments, amide, ester, imide, ueride and/or urethane linkages are also aromatic.

Hard segments useful in the invention may be represented by formula (I) or (II):
-[A-B]ₙ-A- (I)
-[B-A]ₙ-B- (II)
where n is 1-10, A is the residue of a diacid, diisocyanate, aromatic diol, tetracarcarboxylic acid or in formula (II) of a ring opened lactone, lactide or hydroxy acid, or a ring opened lactam or amino acid, B is a residue of a diamine, diol, or aminoalcohol and where the linkages between the A and B residues are amide, ester, aromatic ether, imide, ureide and/or urethane linkages.

For purposes of this application, the term “poly” applied to the definition of a hard segment includes structures of formulas (I) and (II) wherein n is 1. In some embodiments of the invention the number n will be 2-10, for instance 3-8.

Based upon the combinations of hard and soft segments and their chemistries, the new balloon can be made be stronger with better dimensional stability than polyurethanes and Pebax 6333 balloons, and still be as soft, or softer, than those materials. Alternatively, the balloon can be made as strong as PET balloons, but with better softness and flexibility.

The polymers employed in the invention have suitability as materials for forming catheters, catheter balloons, stents, blood filters, endoscopes or portions thereof. The polymers have particular suitability as balloon materials. The uniform lengths will enable faster phase separation in the block copolymer system during melt processing or solid thermal transformation processes like balloon molding. The faster phase separation process helps develop stronger balloon wall structure during balloon forming. Because of the stronger hard domain structure and more completed phase separation, the balloon will be more dimensionally stable, i.e., less change in wall thickness and sizes during sterilization. In some cases this will allow elimination of costly extra heat-set, or re-sizing steps from a balloon manufacturing process.

The improved dimensional stability is also of particular benefit in other medical devices, such as polymer stents, that may be subjected to post-formation solid-state thermoforming steps before sterilization.

Additionally, because of the well-controlled phase separation process, the morphology of final material structure can be tailored to achieve desired physical properties. In some cases, due to the nature of the fast phase separation or hard segment crystallization rate, the crystalline structure may be nano-ribbon like (with a high aspect ratio).

It is known that block copolymers can be induced to produce self-organized nano-scale planar, pillar or spherial structures of phase separated blocks, depending on factors such as material on which a film is deposited and the relative amounts of the different blocks in the copolymer. Such self-organized structures can be exploited in a variety of ways. Diblock copolymers of polycaprolactone/poly(ethylene glycol) at a ratio of 23-77%, having a narrow molecular weight distribution have been reported to provide a phase separated surface structure having hard polycaprolactone islands surrounded by, and raised about 27 nm above, a hydrophilic polyethylene glycol matrix. This surface has an affinity for endothelial cells and is also hydrophilic, a combination of properties not found in either polycaprolactone, polyethylene glycol or in block copolymers that do not show microphase separation. See S. Hsu, et al, “Biocompatibility of poly(ε-caprolactone)/poly(ethylene glycol) diblock copolymers with nanophase separation,” Biomaterials 25 (2004) 5593-5601. A block copolymer in which the hard segment has a high uniformity in the hard segment in accordance with the present invention will be facilitated in forming such nanophase structure. For this reason a medical device such as a stent having a surface of such a block copolymer, for instance a coated metal stent or a stent formed of such a block copolymer, may provide improved biocompatibility.

The polymer materials used can be processed via conventional extrusion or molding equipment for thermoplastic materials. Formation of tubing and balloons from the tubing follow conventional procedures.

The hard segments are obtained by reaction of a hard segment precursor with a soft segment precursor. The hard segment precursor is typically formed by controlled stoichiometric condensation or addition reactions between compounds providing the respective A and B groups of the hard segment. This may be for instance reaction of diacid, dialkyl ester, acid anhydride or lactone, with a diol to form a polyester hard segment, reaction of a diacid, dialkyl ester acid anhydride or lactone, with a diamine to form a polyamide hard segment, reacton of a tetracarboxylic acid and a diamine to form a polyimide, reaction of a diol and diisocyanate to form a polyurethane, and reaction of a diamine and a diisocyanate to form a polyureide. The reactions may be controlled to provide terminal acid, hydroxy, amine or isocyanate groups on the hard segment precursor. Two or more different reactions may be run in sequence in which case the groups A, and/or B may be different within a single hard segment. For instance a diamine may be reacted with an excess of diisocyanate to produce an extended diisocyanate having ureide linkages, and the extended diisocyanate may then be reacted with an excess of a diol to produce an extended diol having ureide and urethane linkages at locations reflecting the sequence of reaction.

Examples of diacids that may be used to produce hard segment precursors include terephthalic acid, 1,3-phthalic acid, 1,2-dicarboxylic acid, naphthalene dicarboxylic acid, oxalic acid, malonic acid, succinic acid, glutaric acid, adipic acid, pimelic acid, suberic acid, azelaic acid, sebacic acid, 1,10-decanoic acid, 1,12 dodecanedioic acid. Of course, the equivalent reactions of acid chlorides, acid anhydrides or lower alkyl esters derived from such diacids can be used to provide diacid residues in the hard segment precursor.

Examples of lactones and lactams include ε-caprolactone, ε-caprolactam, δ-valerolactone, laurlolactam, lauorolactone and lactide. Examples of aminoacids and hydroxyacids include mandelic acid, lactic acid, 3-hydroxypropionic acid, 4-amino-benzoic acid, aminopropionic acid, 4-hydroxybenzoic acid, and 11-aminoundecanoic acid.

Examples of aromatic tetracarboxylic acids and anhydrides that may be employed to form polyimide hardsegment precusors include pyromellitic acid 1,2,3,4-benzenetetracarboxylic dianhydride, 2,3,5,6-pyridinetetracarboxylic dianhydride, 2,3,4,5-thiophenetetracarboxylic dianhydride, 2,2′,3,3′-benzophenonetetracarboxylic dianhydride, 2,3′,3,4′-benzophenonetetracarboxylic dianhydride, 3,3′,4,4′-benzophenonetetracarboxylic dianhydride, 3,3′,4,4′-biphenyltetracarboxylic dianhydride, 2,2′,3,3′-biphenyltetracarboxylic dianhydride, 2,3,3′,4′-biphenyltetracarboxylic dianhydride, 3,3′,4,4′-p-terphenyltetracarboxylic dianhydride, 2,2′,3,3′-p-terphenyltetracarboxylic dianhydride, 2,3,3′,4′-p-terphenyltetracarboxylic dianhydride, 1,2,4,5-naphthalenetetracarboxylic dianhydride, 1,2,5,6-naphthalenetetracarboxylic dianhydride, 1,2,6,7-naphthalenetetracarboxylic dianhydride, 1,4,5,8-naphthalenetetracarboxylic dianhydride, 2,3,6,7-naphthalenetetracarboxylic dianhydride, 2,3,6,7-anthracenetetracarboxylic dianhydride, 1,2,5,6-anthracenetetracarboxylic dianhydride, 1,2,6,7-phenanthrenetetracarboxylic dianhydride, 1,2,7,8-phenanthrenetetracarboxylic dianhydride, 1,2,9,10-phenanthrenetetracarboxylic dianhydride, 3,4,9,10-perylenetetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, 1,4,5,8-tetrachloronaphthalene-2,3,6,7-tetracarboxylic dianhydride, bis(2,3-dicarboxyphenyl)ether dianhydride, bis(3,4-dicarboxyphenyl)ether dianhydride, bis(2,3-dicarboxyphenyl)methane dianhydride, bis(3,4-dicarboxyphenyl)methane dianhydride, bis(2,3-dicarboxyphenyl)sulfone dianhydride, bis(3,4-dicarboxyphenyl)sulfone dianhydride, 1,1-bis(2,3-dicarboxyphenyl)ethane dianhydride, 1,1-bis(3,4-dicarboxyphenyl)ethane dianhydride, 2,2-bis(2,3-dicarboxyphenyl)propane dianhydride, 2,2-bis(3,4-dicarboxyphenyl)propane dianhydride, 2,6-bis(3,4-dicarboxyphenyl)pyridine dianhydride, 1,1,1,3,3,3-hexafluoro-2,2-bis(3,4-dicarboxyphenyl) propane dianhydride, and bis(3,4-dicarboxyphenyl)dimethylsilane dianhydride.

Examples of diisocyanates include aromatic diisocyanates and aliphatic diisocyanates. Aromatic diisocyanates may be, for instance, 4,4′-diphenylmethane diisocyanate, 2,4-toluene diisocyanate, 2,6-toluene diisocyanate, 2,3,5,6-tetramethyl-1,4-diisocyanatobenzene (also known as “durene diisocyanate”), xylylene diisocyanate, 1,5-diisocyanatonaphthalene, 1,4-phenylene-diisocyanate, 1,3-phenylene diisocyanate, tetrachlorophenylene diisocyanate, 2,6-diethyl-p-phenylenediisocyanate, 3,5-diethyl-4,4′-diisocyanatodiphenylmethane, 4,4′-stilbene diisocyanate, 3,3′-dimethyl-4,4′-biphenylene diisocyanate (TODI), and 3,3′-dimethoxy-4,4′-diisocyanato-diphenyl. Aliphatic diisocyanantes may be, for instance, 4,4′-dicyclohexylmethane diisocyanate, 1,3-bis-(isocyanatomethyl) cyclohexane, ethylene diisocyanate, 1,4-tetramethylene diisocyanate, 1,6-hexamethylene diisocyanate (HDI), cyclobutane-1,3-diisocyanate, cyclohexane 1,3- and -1,4-diisocyanate, 1-isocyanato-3,3,5-trimethyl-5-isocyanatomethyl-cyclohexane, 2,4- and 2,6-hexahydrotoluene diisocyanates, hexahydro-1,3- and 1,4-phenylene diisocyanate, and perhydro-2,4- and 4,4′-diphenylmethane diisocyanate.

Examples of aromatic diols are catechol, resorcinol and hydroquinone, 2,2-(4,4′-dihydroxydiphenyl)-propane (i.e., bisphenol A), 4,4′-dihydroxybiphenyl, 2,2-(4,4′-dihydroxydiphenyl)-sulfone, 2,2-(4,4′-dihydroxydiphenyl)-butane, 3,3-(4,4′-dihydroxydiphenyl)-pentane, α,α′-(4,4′-dihydroxydiphenyl)-p-diisopropylbenzene, and the like.

Examples of aromatic diamines that may be employed to provide the residue B include p-phenylenediamine m-phenylenediamine, 1,4-diaminonaphthalene, 1,5-diaminonaphthalene, 1,8-diaminonaphthalene, 2,6-diaminonaphthalene, 2,7-diaminonaphthalene, 2,6-diaminoanthracene, 2,7-diaminoanthracene, 1,8-diaminoanthracene, 2,4-diaminotoluene, 2,5-diamino(m-xylene), 2,5-diaminopyridine, 2,6-diaminopyridine, 3,5-diaminopyridine, 2,4-diaminotoluenebenzidine, 3,3′-diaminobiphenyl, 3,3′-dichlorobenzidine, 3,3′-dimethylbenzidine, 3,3′-dimethoxybenzidine, 2,2′-diaminobenzophenone, 4,4′-diaminobenzophenone, 3,3′-diaminodiphenyl ether, 4,4′-diaminodiphenyl ether, 3,4′-diaminodiphenyl ether, 3,3′-diaminodiphenylmethane, 4,4′-diaminodiphenylmethane, 4,4′-diaminodiphenylmethane, 3,4′-diaminodiphenylsulfone, 4,4′-diaminodiphenylsulfone, 3,3′-diaminodiphenylsulfide, 3,4′-diaminodiphenylsulfide, 4,4′-diaminodiphenylsulfide, 4,4′-diaminodiphenyl thioether, 4,4′-diamino-3,3′,5,5′-tetramethyldiphenyl ether, 4,4′-diamino-3,3′,5,5′-tetraethyldiphenyl ether, 4,4′-diamino-3,3′,5,5′-tetramethyldiphenylmethane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 2,6-bis(3-aminophenoxy)pyridine, 1,4-bis(3-aminophenylsulfonyl)benzene, 1,4-bis(4-aminophenylsulfonyl)benzene, 1,4-bis(3-aminophenyl thioether)benzene, 1,4-bis(4-aminophenyl thioether)benzene, 4,4′-bis(3-aminophenoxy)diphenyl sulfone, 4,4′-bis(4-aminophenoxy)diphenyl sulfone, bis(4-aminophenyl)amine, bis(4-aminophenyl)-N-methylamine, bis(4-aminophenyl)-N-phenylamine, bis(4-aminophenyl)phosphine oxide, 1,1-bis(3-aminophenyl)ethane, 1,1-bis(4-aminophenyl)ethane, 2,2-bis(3-aminophenyl)propane, 2,2-bis(4-aminophenyl)propane, 2,2-bis(4-amino-3,5-dimethylphenyl)propane, 4,4′-bis(4-aminophenoxy)biphenyl, bis[4-(3-aminophenoxy)phenyl]sulfone, bis[4-(4-aminophenoxy)phenyl]sulfone, bis[4-(4-aminophenoxy)phenyl]ether, bis[4-(4-aminophenoxy)phenyl]methane, bis[3-methyl-4-(4-aminophenoxy)phenyl]methane, bis[3-chloro-4-(4-aminophenoxy)phenyl]methane, bis[3,5-dimethyl-4-(4-aminophenoxy)phenyl]methane, 1,1-bis[4-(4-aminophenoxy)phenyl]ethane, 1,1-bis[3-methyl-4-(4-aminophenoxy)phenyl]ethane, 1,1-bis[3-chloro-4-(4-aminophenoxy)phenyl]ethane, 1,1-bis[3,5-dimethyl-4-(4-aminophenoxy)phenyl]ethane, 2,2-bis[4-(4-aminophenoxy)phenyl]propane, 2,2-bis[3-methyl-4-(4-aminophenoxy)phenyl]propane, 2,2-bis[3-chloro-4-(4-aminophenoxy)phenyl]propane, 2,2-bis[3,5-dimethyl-4-(4-aminophenoxy)phenyl]propane, 2,2-bis[4-(4-aminophenoxy)phenyl]butane, 2,2-bis[3-methyl-4-(4-aminophenoxy)phenyl]butane, 2,2-bis[3,5-dimethyl-4-(4-aminophenoxy)phenyl]butane, 2,2-bis[3,5-dibromo-4-(4-aminophenoxy)phenyl]butane, 1,1,1,3,3,3-hexafluoro-2,2-bis(4-aminophenyl)propane, 1,1,1,3,3,3-hexafluoro-2,2-bis[3-methyl-4-(4-aminophenoxy)phenyl]propane and substitution products thereof resulting from substitution of a halogen atom or alkyl group into an aromatic nucleus. Examples of aliphatic diamines that may be employed to provide the residue B include 1,2-ethylene diamine, 1,2-propylene diamine, 1,3-propylene diamine, isomers of butylene diamine for instance 1,4-butylene diamine, isophorone diamine, propane-2,2-cyclohexyl amine, methane-bis-(4-cyclohexyl amine), and hydrogenation products resulting from hydrogenation of the aromatic diamines described herein.

Diols that may be used in producing the residue B, any of the aromatic diols already mentioned above; hydrogenation products resulting from hydrogenation of such aromatic diols, for instance hydrogenated Bisphenol A; alkylene glycols such as ethylene glycol, propylene glycol, butylene glycol, and neopentyl glycol; 1,3 propane diol; 1,4-butane diol; cyclohexane diols such as 1,3-cyclohexane diol, and 1,4-cyclohexane diol; cyclohexane dimethanol; alkoxylated bisphenol A, for instance ethoxylated bisphenol A or propoxylated bisphenol-A having from 1 to 3 alkoxylate moieties per molecule; bicyclic and tricylic diols such as 4,8-bis-(hydroxymethyl)-tricyclo [5.2.1.0.sup.2,6] decane and the like.

Examples of amino alcohols include ethanolamine, propanolamine, 4-amino phenol, 2-aminophenol, and 3-aminophenol.

In some embodiments it is desirable that the hard segments of the polymer crystallize rapidly from the melt. To that end, it is generally preferred that the hard segment precursor have aromatic content in at least one of the moieties A and B, and/or that aliphatic moieties be relatively small, e.g. have four or fewer methylene groups between carbon atoms attached to a heteroatom.

To provide hard segments having a substantially uniform molecular weight, it is generally desirable to purify the hard segment precursor before joining the hard segments with soft segments to form the polymers used in the invention. This can be done for instance by dissolution and selective crystallization, by extraction or distillation of unreacted starting materials or undesired byproducts, and/or by chromatographic separation of molecular weight fractions. In cases where the hard segment precursors are built up in sequential reactions, purification after each step can facilitate production of substantially uniform hard segments.

In the present invention, the uniformity of the molecular weight of the hard segment precursor can be ascertained the ratio Mw/Mn, wherein Mw represents the weight average molecular weight and Mn represents the number average molecular weight of the precursor. The theoretical lower limit of this ratio is 1.0. In a typical polyamide or polyester block copolymer this ratio for the hard segment is about 2 or more. In some embodiments of the invention the ratio Mw/Mn is desirably not more than 1.5, more preferably not more than 1.3, for instance from about 1.0 to about 1.2. The Mw values can be determined by light scattering and GPC. The Mn values can be determined end group analysis and ebulliometry.

The soft segments may be aliphatic polyether, polyether ester, polyester polyalkylene, or polyalkenylene blocks. They may be obtained from a polymeric precursor component that has a lower glass transition temperature (Tg) than the hard segment precursor, suitably below ambient temperature, for instance 0° C. or less. Polyether diols are preferred soft segment precursors.

Polyether diols may be produced by known methods, for example by the anionic polymerization of alkylene oxides with the addition of at least one starter molecule which contains two reactive hydrogen atoms, or by the cationic polymerization of alkylene oxides. Suitable alkylene oxides contain 2 to 4 carbon atoms in their alkylene radical. Examples thereof include ethylene oxide and/or 1,2-propylene oxide, tetrahydrofuran, 1,2-propylene oxide and 1,2- or 2,3-butylene oxide. Polyether diols from ethylene oxide 1,2-propylene oxide and/or tetrahydrofuran are preferably used. The alkylene oxides may be used individually, alternately in succession or as mixtures to prepare the polyether diol. Suitable starter molecules include water or diols such as ethylene glycol, 1,2-propanediol and 1,3-propanediol, diethylene glycol, dipropylene glycol, 1,4-ethanediol, etc. Suitable number average molecular weights may be from about 200 to about 8000, for instance 300 to 3500, especially 500 to 1500. Poly(tetramethylene oxide) diol may be used. Amine terminated polyethers, such as Jeffamine® polyether diamines may be employed.

Polyether ester diols may also be used to form soft segments for the polymers of the invention. These polyether ester diols may be obtained by the ethoxylation, propoxylation, or 1,4-butoxylation of polyester diols.

Suitable polyester diols may be produced, for example, from organic dicarboxylic acids comprising 2 to 12 carbon atoms, preferably aliphatic dicarboxylic acids comprising 4 to 12 carbon atoms, and polyhydric alcohols, preferably diols, comprising 2 to 12 carbon atoms, preferably 4 to 12 aliphatic carbon atoms, or polyether diols. Examples of suitable dicarboxylic acids include: adipic acid, suberic acid, azelaic acid, sebacic acid, decanedioic acid and terephthalic acid. The dicarboxylic acids may be used either individually or in admixture with each other. Instead of the free dicarboxylic acids, the corresponding dicarboxylic acid derivatives, such as dicarboxylic acid mono and/or diesters of alcohols comprising 1 to 4 carbon atoms may be used, or dicarboxylic anhydrides may also be used. Mixtures of dicarboxylic acids may be used. Examples of diols include polyethylene glycol, polypropylene glycol, poly(tetramethylene ether) diol, poly(hexamethylene ether diol and mixtures thereof. In addition, polyester diols of lactones, e.g. poly(ε-caprolactone), may be used. Polyester diols with a number average molecular weight of 400 to 6000, for instance 500 to 3500, are exemplary.

Other polymers that maybe used as soft segments are functionalized polyolefins and diene polymers. Hydroxy or carboxy terminated polyethylenes and polybutadienes are examples.

The uniformity of molecular weight of the soft segment is not particularly important. Suitably the distribution may be as wide as the distribution in commercially commercial diols of the type described, for instance the Mw/Mn ratio may be within the range of from about 1.2 to about 3, or even wider. However, in some embodiments diols having a molecular weight ratio of 1.75 or less, for instance 1.15 to 1.70, may be used as the soft segment precursor. When the molecular weight distribution (Mw/Mn ratio) of a polyether diol is 1.75 or less, a block copolymer based thereon may have further improve microphase separation of the hard and soft segments, improving elasticity of the polymer.

The segmented polymer of the invention are suitably provided by appropriate condensation or addition reaction using a reaction that uses the available end groups on the respective hard and soft segment precursors to produce a covalent linkage. In some cases it may be desirable to cap one or the other of the hard segment or soft segment precursors or to utilize a chain extender to provide a suitable linkage. For instance if the hard and soft segment precursor are both terminated with active hydrogen atom groups (e.g. hydroxyl or amine), a diisocyanate, diacid or anydride or alkyl ester thereof may be employed to cap either one of the precursors with a functionality that will form a linkage with both.

Segmented polymers that are composed of alternating hard and soft segments in which the hard segments are of uniform size and the soft segments are of variable size are known. Documents disclosing such materials include: U.S. Pat. No. 6,172,167 B1, Staupert et al; US 2002/0050422 A1 Bezemer et al; M. Niesten and R. Gaymans, “Tensile and elastic properties of segmented copolyetheresteramides with uniform aramid units,” Polymer 42 (2001) 6199-6207; R. Gaymans et al., “Nano-Reinforcement by Crystallization in Blockcopolymers,” http://www.polymers.nl/>news archive>nanoreinforcement, Dutch polymer Institute (2004); J. Feijen et al, “Engineering Polymers With Uniform Crystallisable Units,” http://www.polymers.nl/>projects>project 140, Dutch polymer Institute (undated).

Segmented polyether polyurethanes are described in U.S. Pat. No. 6,777,524, Shimizu, in which the polyether is a poly(tetramethylene oxide) diol having a number average molecular weight of from 500 to 4,000, a molecular weight distribution (Mw/Mn) of 1.75 or less, and a content of high molecular weight poly(tetramethylene oxide) molecules of 10% by weight or less.

In the present invention, a hard segment content of 40% to about 85%, for instance 45%-80%, on the basis of the total weight of the polymer, is suitable for catheter and balloon applications.

In one exemplary embodiment of the invention the hard segments are polyamide segments corresponding to a formula (II) above, where B is a residue of p-phenylene diamine, A is a residue of terephthalic acid, and n is from 2 to 8, and the soft segment is a residue of poly(tetramethylene oxide) diol, and the polyamide content is 45 to about 75% by weight. In another embodiment of the invention the hard segments are polyester segments corresponding to formula (I) above, where A is a residue of terephthalic acid, B is a residue of butylene glycol, and the soft segment is a residue of poly(tetramethylene oxide) diol.

All published documents, including all U.S. patent documents, mentioned anywhere in this application are hereby expressly incorporated herein by reference in their entirety. Any copending patent applications, mentioned anywhere in this application are also hereby expressly incorporated herein by reference in their entirety.

The above examples and disclosure are intended to be illustrative and not exhaustive. These examples and description will suggest many variations and alternatives to one of ordinary skill in this art. All these alternatives and variations are intended to be included within the scope of the claims, where the term “comprising” means “including, but not limited to.” Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all claims which possess all antecedents referenced in such dependent claim if such multiple dependent format is an accepted format within the jurisdiction. In jurisdictions where multiple dependent claim formats are restricted, the following dependent claims should each be also taken as alternatively written in each singly dependent claim format which creates a dependency from any antecedent-possessing claim.

1. A medical device comprising a polymer, the polymer having a plurality of hard segments and a plurality of soft segments, wherein the polymer hard segments have a substantially uniform molecular weight distribution.

2. A device as in claim 1 wherein the hard segments have a molecular weight distribution ratio, Mw/Mn, of 1.5 or less.

3. A device as in claim 1 wherein the ratio Mw/Mn is 1.3 or less.

4. A device as in claim 1 wherein the ratio Mw/Mn is 1.1-1.2.

5. A device as in claim 1 wherein the polymer is a reaction product of a difunctional hard segment precursor and a co-reactive difunctional soft segment precursor, wherein the difunctional hard segment precursor was processed to provide a molecular weight distribution ratio, Mw/Mn, of 1.5 or less before reaction thereof with said difunctional soft segment precursor to produce said reaction product.

6. A device as in claim 5 wherein the hard segments include amide, ester, imide, aromatic ether, ueride and/or urethane linkages.

7. A device as in claim 1 wherein the soft segments include aliphatic polyether, polyester ether, polyester, polyolefin or diene polymer blocks or mixtures thereof.

8. A device as in claim 7 wherein the soft segment precursor is a polymeric component that has a lower glass transition temperature (Tg) than the hard segment precursor.

9. A device as in claim 1 wherein the hard segments are represented by formula (I) or (II):
-[A-B]ₙ-A- (I)
-[B-A]ₙ-B- (II)
where n is 1-10, A is the residue of a diacid, diisocyanate, aromatic diol, tetracarcarboxylic acid or in formula (II) of a ring opened lactone, lactide or hydroxy acid, or a ring opened lactam or amino acid, B is a residue of a diamine, diol, or aminoalcohol and where the linkages between the A and B residues are amide, ester, aromatic ether, imide, ureide and/or urethane linkages.

10. A device as in claim 9 wherein n is 2-10.

11. A device as in claim 9 wherein at least one of the moieties A and B has aromatic content.

12. A device as in claim 9 wherein at least one of the moieties A and B is an aliphatic group and the aliphatic groups have four or fewer methylene groups between carbon atoms attached to a heteroatom.

13. A device as in claim 9 wherein the soft segments are aliphatic polyether, polyester ether, polyester, polyolefin or diene polymer blocks, or mixtures thereof.

14. A device as in claim 9 wherein the soft segments are polyalkylene ether blocks having number average molecular weights of from about 200 to about 8000.

15. A device as in claim 9 wherein the soft segments are polyolefin or diene polymer blocks.

16. A device as in claim 9 wherein the hard segments have a molecular weight distribution ratio, Mw/Mn, of 1.5 or less.

17. A device as in claim 16 wherein the soft segments have a molecular weight distribution ratio, Mw/Mn, of 1.75 or less.

18. A device as in claim 9 wherein both A and B are aromatic residues linked by amide, ester, ether, and/or urethane linkages.

19. A device as in claim 1 wherein the polymer has a hard segment content of 40% to about 85%, by weight of the polymer.

20. A device as in claim 1 wherein the device is a catheter, catheter balloon, stent, blood filter, endoscope or portion thereof.

21. A device as in claim 1 wherein the device is a catheter balloon, the hard segments comprise aromatic residues linked by amide, ester, ether, imide and/or urethane linkages, the hard segment content is 45-85% by weight of the polymer, the hard segments have a molecular weight distribution ratio, Mw/Mn, of 1.5 or less and the soft segments are polyether, polyester ether, polyester, polyolefin or diene polymer blocks, or mixtures thereof having number average molecular weights of from of 500 to 1500.

22. A polymer having a plurality of hard segments and a plurality of soft segments, wherein the hard segments have a molecular weight distribution ratio, Mw/Mn, of 1.5 or less, the hard segments comprise aromatic residues linked by amide, ester, ether, imide and/or urethane linkages, the hard segment content is 45-85% by weight of the polymer, the hard segments have a molecular weight distribution ratio, Mw/Mn, of 1.5 or less and the soft segments are polyether, polyester ether, polyester, polyolefin or diene polymer blocks, or mixtures thereof, having number average molecular weights of from of 500 to 1500.

23. A polymer as in claim 22 wherein the soft segments have a molecular weight distribution ratio, Mw/Mn, of 1.75 or less.

24. A polymer as in claim 22 wherein the soft segments are polyalkylene ether blocks.

25. An implantable medical device having a polymer coating of block copolymer thereon, the coating having a surface forming islands of phase separated first blocks surrounded by a matrix of second blocks, the first blocks characterized by having cell adhesion compatibility for a targeted cell type and the second blocks being hydrophilic and characterized by a lower cell adhesion compatibility for said targeted cell type than said first blocks.

26. An implantable medical device as in claim 25 wherein the islands of first blocks are raised relative to the surrounding matrix of second blocks.

27. An implantable medical device as in claim 25 wherein the first blocks are poly(ε-caprolactone) and the second blocks are polyethylene glycol.
